(19) United States
(12) Patent Application Publication
(10) Pub. No.: US 2015/0033477 A1
(43) Pub. Date: Feb. 5, 2015

(54) Auto Emergency Tool

(71) Applicants: Bennett S. Rubin, Pepper Pike, OH (US); Richard C. Adamany, Chagrin Falls, OH (US)

(72) Inventors: Bennett S. Rubin, Pepper Pike, OH (US); Richard C. Adamany, Chagrin Falls, OH (US)

(73) Assignee: InterDesign, Inc., Solon, OH (US)

(21) Appl. No.: 14/379,436

(22) PCT Filed: Feb. 17, 2012
(86) PCT No.: PCT/US2012/025639

§ 371 Date: Aug. 18, 2014

(51) Int. Cl. B25F 1/00; A62B 3/00

(52) U.S. Cl. CPC B25F 1/006; A62B 3/00
USPC 7/158

(57) ABSTRACT

An ergonomic auto emergency tool for alternatively functioning as a flashlight, a seat belt cutter and a motor vehicle window glass breaker. The auto emergency tool includes a main portion and a projecting portion extending from a joining portion and being integral with the main portion, and defining a seat belt-receiving notch therebetween. A knife blade extends across the notch proximate the joining portion. An inner main portion-facing upper surface of the projecting portion has a gentle curve for facilitating the movement of the tool towards and through a seat belt, and the bottom outer surface of the projecting portion is curved for both easy handling and for enabling a firm grip when the tool is used to break window glass. The window-breaking mechanism includes a depressible plunger cover for releasing a spring-loaded impact member.

### BACKGROUND OF THE INVENTION

1. Field of the Invention

This invention relates to handheld emergency tools, and in particular to small emergency tools to enable a person to escape from a motor vehicle, such as an automobile, when the motor vehicle is in an emergency situation.

2. Description of the Prior Art

There are many incidences where persons in a motor vehicle, such as an automobile, require assistance to escape from the motor vehicle quickly and safely. This could occur in the event the motor vehicle was involved in a collision with another motor vehicle or with some other object, became immersed in water, caught on fire and the like. In most motor vehicles, there are two obstacles for preventing easy escape from the vehicle; these are the windows of the vehicle and the seat belt which is used to hold an occupant in place. Furthermore, a person in distress from such a motor vehicle incident requires assistance in both finding a path to escape the vehicle and to emit a signal to possible rescuers. If an occupant is unable to open a window in the vehicle as a path of escape, it would be necessary to break the window in as short a period of time as possible while requiring limited strength and range of motion, particularly if the occupant is injured, fragile, weak, and in some instances having a little time or room to break the window. Also, there may be instances where an occupant is unable to open a locked seat belt apparatus, such as in the event the operating mechanism is inoperative possibly because of an accident, because the occupant is unable to reach the release mechanism for the seat belt, because obstacles impeding access to release the operating mechanism, because the operating mechanism is malfunctioning or for some other reason cannot release the seat belt.

Commonly owned U.S. Pat. No. 7,557,720, entitled “Personal Emergency Device,” is directed to a personal emergency device which can be kept on a keyring and is useful in various emergency functions, such as those directed to emergency situations involving automobiles. This device has been found very useful because it is small and provides a device for cutting an automobile vehicle's seat belt webbing in the event the driver or passengers are unable to unfasten their seat belts, it includes a device for breaking tempered, unlaminated automobile side window glass by means of a spring-actuated pin having a sharp point that is driven into the glass to break it and which can be easily reset for further use. The foregoing device also includes electronically operated items including a white-light flashlight function, a flashlight and an audible alarm. While the latter device, which is currently on the market and sold as a Swiss+Tech BodyGard 5-in-1 Automobile Emergency Tool, it does not fulfill a part of the market for this type of device. Part of the consuming public would prefer a smaller, more ergonomic device having a smaller depth which is easier to store and hold. Plus, part of the marketplace would prefer a less expensive type of auto emergency tool which would have a lower selling price that would be very effective in emergency situations.

There are other similar devices which have serious setbacks. U.S. Pat. No. 5,657,543, entitled “Emergency Tool,” is directed to a device which is large and bulky, and is for use by emergency personnel having a spring-loaded, trigger operated impact member for breaking glass in a vehicle. The device has an emergency glass-breaking tool, a pivotal knife blade, but no warning or alarm member. The device is fairly large, and would fill up a user's hand. Another known device is described in U.S. Pat. No. 5,952,916, entitled “Hammer Equipped Emergency Signal Device,” having an LED for emitting a warning light, an alarm buzzer and a pair of percussion imparting members which must be swung as a hammer to break the glass. This device is large, requires space to operate and expensive for one to buy. Another device is shown in U.S. Pat. No. 6,418,628, which is allegedly small enough to be carried on a keychain, in a pocket or a purse and includes a spring-loaded glass breaker. It also includes a V-shaped razor blade for cutting a seat belt. This device does not have a light of any sort.

There are other devices known which are of general interest. Referring to U.S. Pat. No. 4,209,870, there is disclosed a handheld cleaning device having a cleaning section and an illuminating system for acting alternatively as a flashlight or as a beacon. An aiming post light is disclosed in U.S. Pat. No. 4,290,095. This light is used for artillery and mortar operations at night, and can be used to provide either steady light or a blinking light, and the blinking light could be red or green, which could be used to assist color blind operators to distinguish between the two colors. An emergency flashlight is described in U.S. Pat. No. 7,033,042. This apparatus has a flashlight body with a battery storage unit and incorporates a hook member for supporting the flashlight on various objects, such as a belt or a handle ring of handbag. It also has a glass-cutting edge with a hammer piece which can be used to cut, strike and break glass and other debris during an emergency situation. None of the latter three devices are small enough to be easily held in a pocket, handbag or on a keyring.

### SUMMARY OF THE INVENTION

An object of the present invention is to provide an emergency tool for use in motor vehicles, such as automobiles, which is extremely compact and provides the features of an easily accessible cutting tool for cutting seat belts, an easy-to-use glass breaker for breaking the tempered, unlaminated glass windows of motor vehicle in times of an emergency, and a light which can be used for enabling the user to detect things in dark places and as a signal device.

Another object of the present invention is to provide an improved emergency tool which is small, ergonomic, and can easily be held in a person's pocket, such as on a keyring or on a handbag, or in an easily accessible place in a motor vehicle.

It is still another object of the present invention to provide a miniature auto emergency tool which is less expensive than existing emergency tools and which provides the functions of being a seat belt cutter, a glass breaker and an illumination or signal device.

It is still another object of the present invention to provide an auto emergency tool as discussed above having simple electronics without the necessity for a circuit board or batteries larger than disc batteries, and can be made and sold relatively inexpensively compared to other vehicle emergency escape tools.

It is yet a further object of the present invention to provide an auto emergency tool having the features indicated above, which is durable, effective in use and able to withstand detrimental conditions, such as water immersion.

These and other objects of the present invention should occur to those skilled in the art from the following description, the accompanying drawings and the claims.

The foregoing objects are achieved according to the preferred embodiment of the invention which includes a housing having a main portion and a projecting portion extending from the main portion at a joining portion. The main portion and the projecting portion are spaced apart to define a recess or notch. A knife blade extends between the main portion and the projecting portion adjacent to the joining portion, the blade having a razor sharp edge. The projecting portion is curved so that when the device is slid across a seat belt that a person is unable to open, the device follows a curved path relative to the seat belt to provide a better cutting angle to facilitate the cutting of the seat belt. A blade cover can be slid in the notch and a detent in the projecting portion follows a longitudinally extending path in the blade cover to guide the blade cover into the notch. A slit in the blade cover admits the knife blade as the blade cover enters the notch, and an indent in the blade cover receives the detent to hold the blade cover in place with a frictional engagement. The blade cover can easily be pulled from the notch by means of a keyring extending through a hole in the key cover. At one end of the auto emergency tool is a translucent dome, cup or lens covering an LED light, and at the other end is a glass breaking mechanism including a guide piece for a spring-loaded impact pin which is released when the guide piece is firmly pressed against the vehicle window to break the glass and enable an escape from the vehicle. The glass breaking mechanism includes components for automatically resetting the mechanism. The auto emergency tool has an LED with an actuating switch on the top of the main body adjacent the LED for turning the light on and off. The auto emergency tool is ergonomic and can easily be held and operated, as well as being stored while taking up little room and causing no discomfort. The batteries for the LED are small disc batteries, and the battery compartment in the main portion extends longitudinally in the tool. The battery cover can easily be opened by means of a captive screw, which is not removable. The auto emergency tool is small in size, effective in operation and less expensive than other similar tools presently available.

### BRIEF DESCRIPTION OF THE DRAWINGS

FIG. 1 is a top, rear perspective view of the auto emergency tool according to the preferred embodiment of the invention.

FIG. 2 is a bottom, front perspective view of the auto emergency tool according to the preferred embodiment of the invention.

FIG. 3 is a top, front perspective view of the auto emergency tool according to the preferred embodiment of the invention.

FIG. 4 is a bottom, rear perspective view of the auto emergency tool according to the preferred embodiment of the invention.

FIG. 5 is a side view of the auto emergency tool according to the preferred embodiment of the invention.

FIG. 6 is a side view of the invention on the opposite side from that shown in FIG. 5 of the preferred embodiment of the invention.

FIG. 7 is a top view of the preferred embodiment of the invention.

FIG. 8 is a bottom view of the preferred embodiment of the invention.

FIG. 9 is a rear end view of the preferred embodiment of the invention.

FIG. 10 is a front end view of the preferred embodiment of the invention.

FIG. 11 is a top, rear perspective view of the preferred embodiment of the invention, with part of the housing omitted to show part of the interior components of the preferred embodiment of the invention.

FIG. 12 is a top, rear perspective view of the preferred embodiment of the invention, with part of the housing and a plunger cover omitted to show part of the interior components of the preferred embodiment of the invention.

FIG. 13 is a top, front perspective view of the preferred embodiment of the invention, with part of the housing omitted to reveal some internal components thereof.

FIG. 14 is a side view of the preferred embodiment of the invention, with part of the housing omitted to reveal part of the interior components of the preferred embodiment with the glass-breaker assembly in a set condition.

FIG. 15 is the same side view of the preferred embodiment of the invention as shown in FIG. 13, with part of the housing and the plunger cover omitted to reveal part of the interior components of the preferred embodiment with the glass-breaker assembly in a set condition.

FIG. 16 is a side cross-sectional view of the preferred embodiment of the invention showing the interior components thereof, with the glass-breaker assembly in a set condition.

FIG. 17 is a side view of the right portion of the preferred embodiment of the invention with the right part of the housing omitted, with the glass-breaker assembly in a set condition.

FIG. 18 is an exploded, perspective view of the preferred embodiment of the invention.

FIG. 19 is a top, rear perspective view of the preferred embodiment of the invention with the blade cover separated from the balance of the unit.

FIG. 20 is a bottom perspective view of the preferred embodiment of the invention with the blade cover separated from the balance of the unit.

FIG. 21 is a side view of the preferred embodiment of the invention showing parameters of the external curved surface of a projecting portion thereof.

FIGS. 22 and 23 are side cutaway views of the preferred embodiment of the invention showing parameters of certain curved surfaces of the interior portion of the projecting portion thereof.

FIG. 24 is a cross-sectional view of the blade cover according to the preferred embodiment of the invention showing parameters of certain curved surfaces thereof

### DETAILED DESCRIPTION OF THE PREFERRED EMBODIMENT

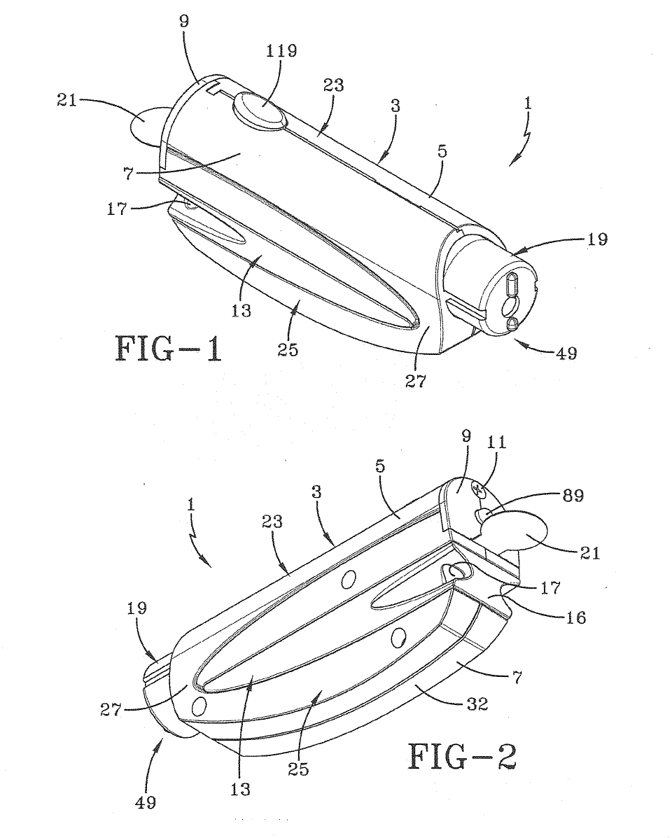

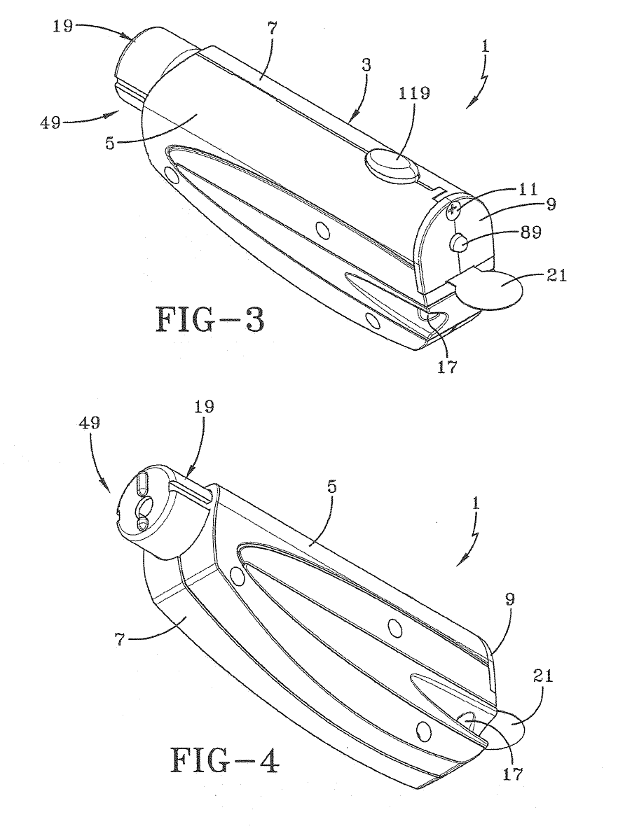

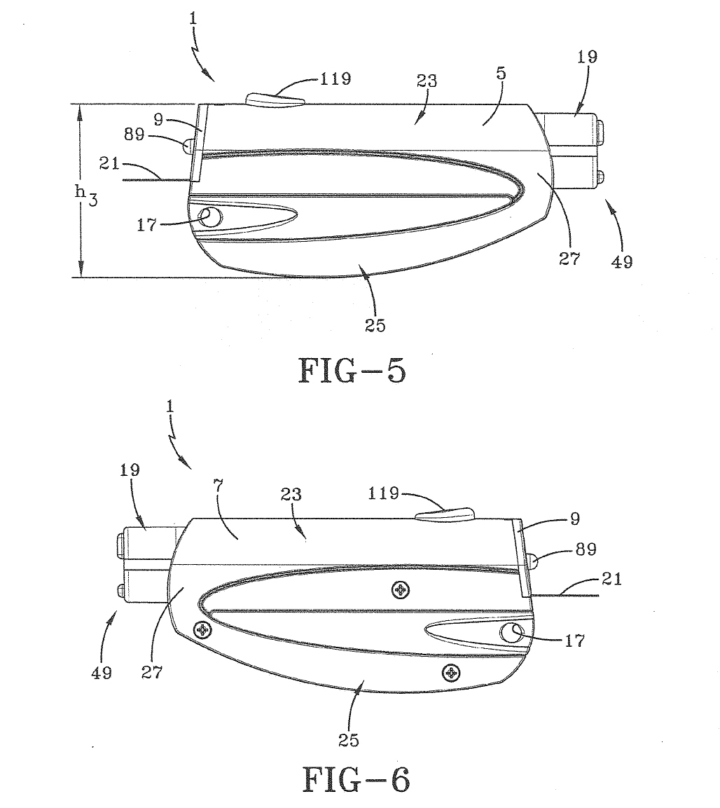

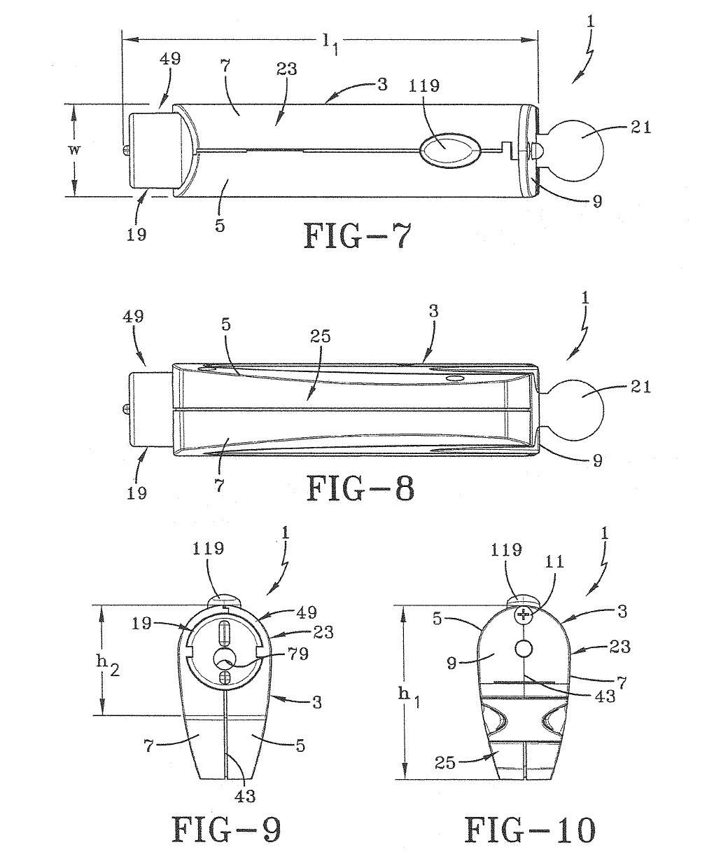

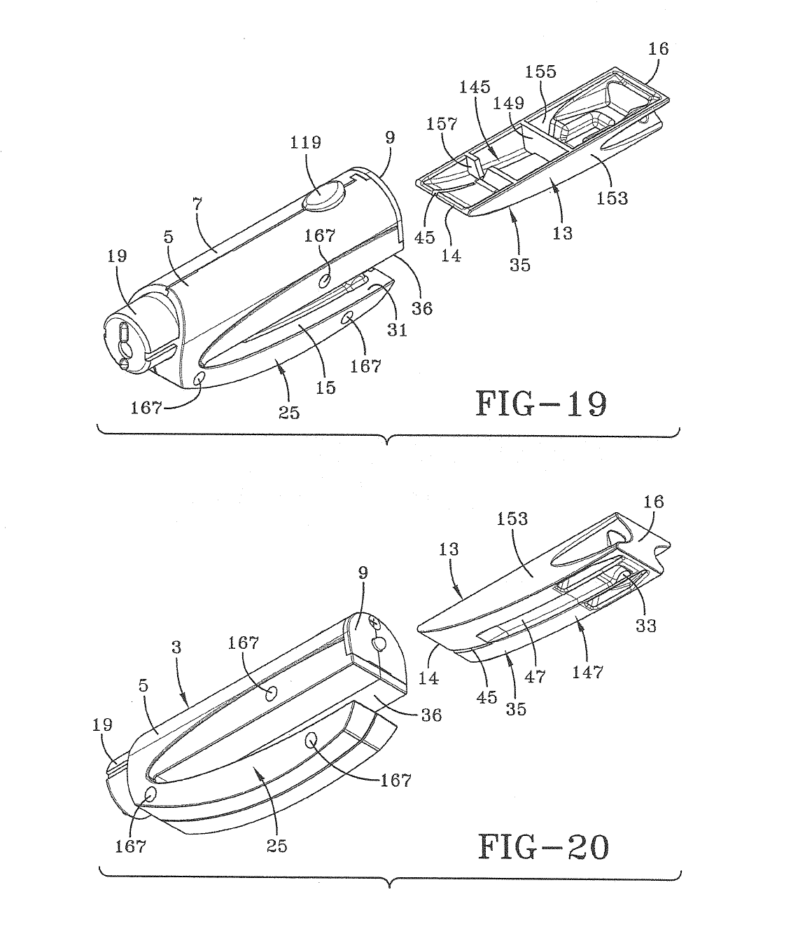

Referring to FIGS. 1-22, an auto emergency tool 1 according to the preferred embodiment of the invention is shown. Auto emergency tool 1 includes a housing 3 preferably made by injection molding. Housing 3 preferably has a right housing part 5 (as shown in FIG. 1 of the drawings) and a left housing part 7. A translucent dome member or lens 9 is mountable in appropriately configured support walls in the interior of housing 3. Lens 9 is held in what is referred to herein as the front end of housing 3 by means of a captive screw 11 entering an appropriate screw receptacle on the interior of housing 3. A blade cover 13, whose purpose is described below, is mounted inside a notch 15 (FIGS. 15 and 19), and blade cover 13 has a hole 17 for receiving a keyring. Blade cover 13 has a nose portion 14, and an opposite actuating end 16. A guide piece or plunger cover 19, whose purpose is also described below, is at the rear end of housing 3. A pull tab 21, discussed below, extends outwardly and forwardly from the intersection of lens 9, and left and right housing parts 5 and 7. Housing 3 should be splash resistant to seal and protect the inner components held inside housing 3. Preferably, housing 3 is waterproof

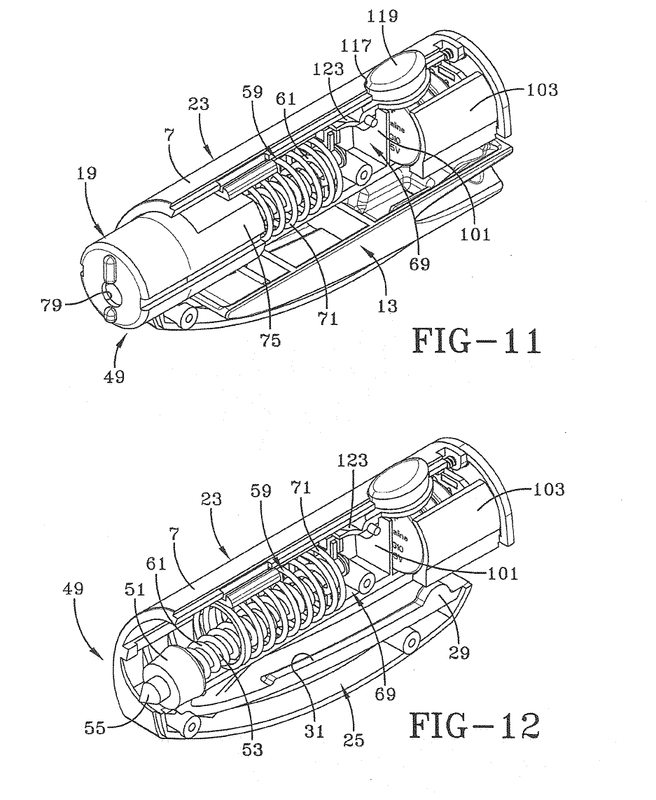

Housing 3 has a main portion 23 and a projecting portion 25. Main portion 23 and projecting portion 25 form a single unit to define therebetween, forwardly from a joining portion 27 which joins portions 23 and 25, notch 15. Blade cover 13, when present in notch 15, is held in place by a friction fit between a detent 29 (FIGS. 12, 15 and 18) in a main portion-facing side 31 of projecting portion 25 and a corresponding indent 33 (FIG. 20) in a projecting portion-facing side or lower part 35 of blade cover 13. Projecting portion 25 has a bottom or outer curved surface 32 (FIGS. 2, 21, 23). Blade cover 13 can easily be withdrawn from housing 3 by pulling on a keyring extending through hole 17 or by otherwise grasping and pulling actuating end 16.

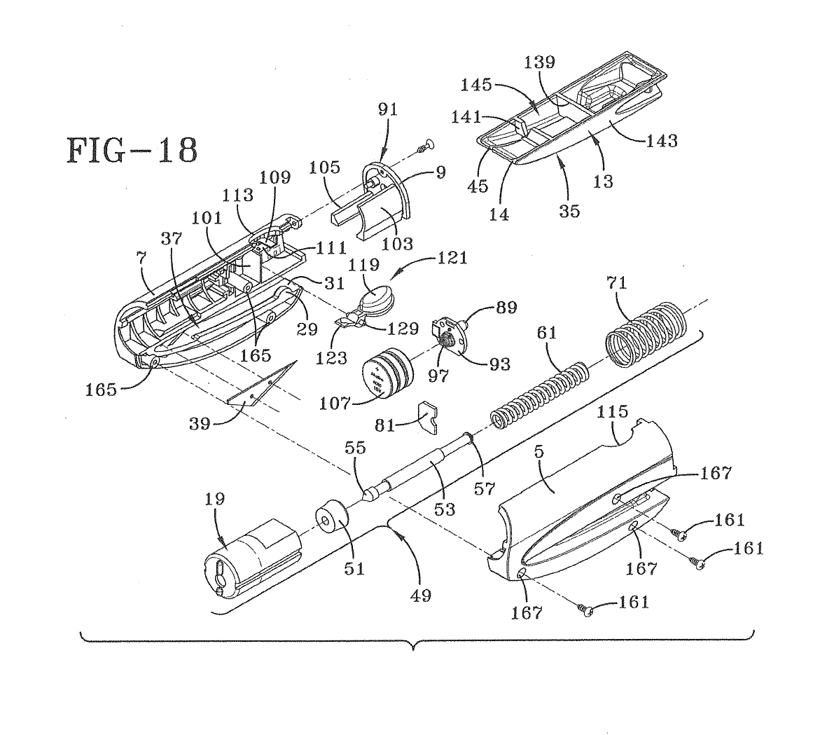

Blade cover 13 is part of a seat-belt cutting assembly 37 of auto emergency tool 1, which is shown in exploded form in FIG. 18. Components of seat-belt cutting assembly 37 are shown most clearly in FIGS. 15, 16, 19 and 21-23 (omitting blade cover 13 in all but FIG. 16). Cutting assembly 37 includes a knife blade 39 which is held fast in housing part 7, such as having been installed by insert molding, and blade cover 13. Knife blade 39 has a razor-like cutting edge 41, which extends into notch 15 at an angle β as shown in FIG. 22, and is proximate joining section 27 of housing 3. Since knife blade 39 is molded in housing part 7, and housing part 7 is basically equal in size to housing part 5, knife blade 39 is an imaginary central plane running along a seam 43 of housing 3, as shown in FIGS. 9 and 10. Referring to FIGS. 18-20, blade cover 13 includes a V-shaped slit 45 which receives the exposed part of knife blade 39 as blade cover 13 is slid into notch 15. Projecting portion-facing side 35 of blade cover 13 has a longitudinally extending indented path 47 having about the same width as detent 29 and terminates at indent 33 (as shown in FIG. 20) to enable the guided sliding of blade cover 13 into notch 15 as blade cover 13 is guided as path 47 slides past detent 29. This guides blade cover 13 as path 47 moves along detent 29, and the guidance is facilitated with the passage of knife blade 37 into V-shaped slit 45 on blade cover 13.

Main body-facing side 31 of projecting portion 25 is basically smooth, other than detent 29, and has a gentle, concave curvature compared to a flat, projecting portion-facing side of main portion 23. The length and curvature of projecting portion 25 facilitates the function of knife blade 39 to cut a seat belt, since auto emergency tool 1 is slid over a seat belt once blade cover 13 has been removed, and surface 31 guides device 1 in a curved motion relative to a seat belt, generating a slicing motion of the seat belt relative to blade 39. This causes cutting edge 41 to approach the belt at an angle to facilitate the cutting of the seat belt by cutting edge 41. The relevant details are discussed below.

Auto emergency tool 1 also includes a glass-breaking mechanism 49. Glass-breaking mechanism 49 can be viewed most clearly through FIGS. 11-20 discussed below. Glass-breaking mechanism 49 includes guide piece 19, which is the only part of mechanism 49 which can be seen externally. Guide piece 19 is movable between the positions shown in FIGS. 11, 13, 14 and 16-17 and which is somewhat extended from housing 3, and a partly recessed position when glass-breaking mechanism 49 is in a glass-breaking condition. Guide piece 19 controls the movement of a pin guide 51 and a contact pin or plunger 53. Pin guide 51 can be integrally formed with contact pin 53 or separate as depicted in FIGS. 16 and 18. Contact pin 53 should be made of strong metal such as steel, and it has a rearward pointed end 55, which contacts and breaks glass windows when actuated, and a bulb end 57 at the forward end of contact pin 53 that prevents contact pin 53 from leaving auto emergency tool 1.

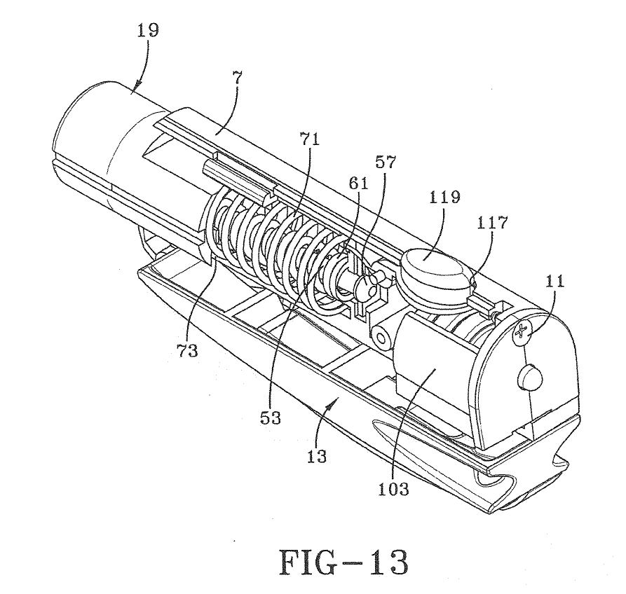

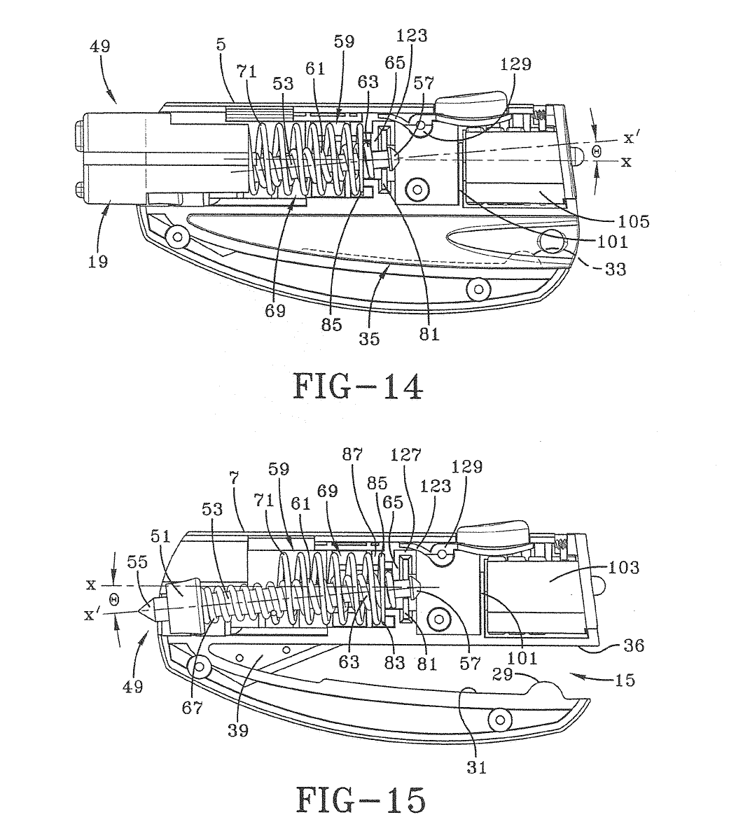

Referring particularly to FIGS. 13-17, contact pin 53 is spring loaded for operation; i.e., it is in a set condition or a cocked state. Contact pin 53 is held at an angle θ of about 5° with respect to the longitudinal axis X. The inclination of contact pin 53 is shown by the imaginary line X. A compression spring assembly 59 surrounds contact pin 53 and provides the mechanism required both to drive contact pin 53 from housing 3 and for resetting glass-breaking mechanism 49. When glass-breaking mechanism 49 is in its loaded state, impact spring 61 (shown as the inner spring) surrounds contact pin 53. Impact spring 61 has an upper first spring end 63 (FIG. 14) abutting a rib 65, rib 65 being part of the interior of housing 3. The contacting of rib 65 by upper first spring end 63 of impact spring 61 causes contact pin 53 to, in effect, pivot to align the longitudinal axis of contact pin 53 with imaginary line X′. Impact spring 61 has an opposite lower second spring end 67 (FIG. 15) which is urged against pin guide 51. Second spring end 67 is preferably anchored in pin guide 51. Contact pin 53 and impact spring 61 are able to pivot between longitudinal axis X and imaginary line X′ within a cavity 69, which is the interior cavity defined by right part 5 and left part 7 of housing 3. Compression spring arrangement 59 also includes a reset spring 71 which surrounds both contact pin 53 and impact spring 61. Reset spring 71 does not pivot.

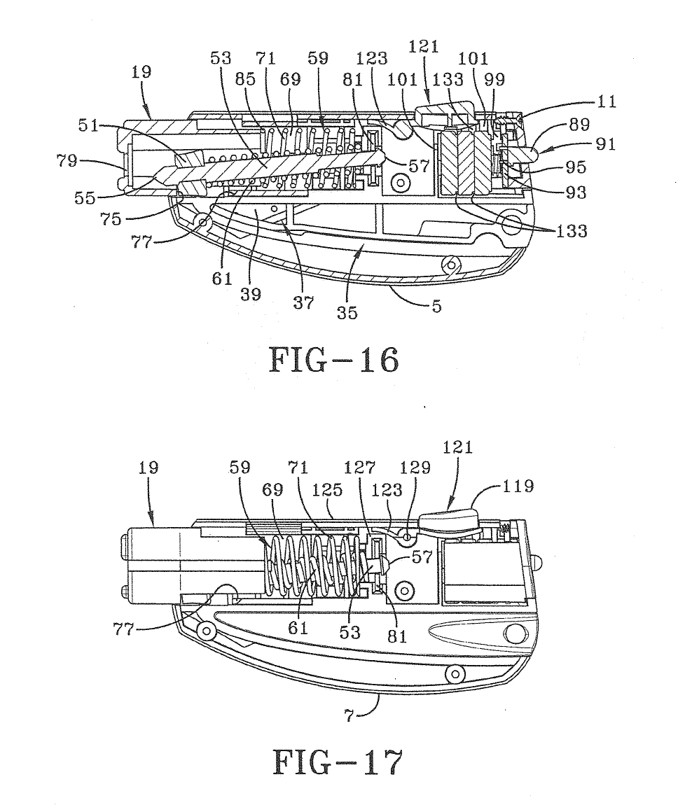

In its set condition, contact pin 53 and impact spring 61 are aligned in their orientation along imaginary line X′. Guide piece 19 has a generally tubular shape with an open lower section 73 (FIG. 13) facing projecting portion body-facing side 36 of main portion 23. The forward part of guide piece 19 has a first arcuate wall section 75 which faces pin guide 51 (FIG. 16). Wall section 75 is a stop for pin guide 51 of contact pin 53 when pin guide 51 abuts wall section 75 in order to release impact pin 51 so that it can be driven into a glass-breaking condition by impact spring 61. A ramp 77 (FIGS. 16, 17) on the interior of housing 3 faces contact pin 53 and pin guide 51. As guide piece 19 is pressed against the side glass of a motor vehicle, guide piece 19 moves pin guide 51 towards ramp 77. This moves pin guide 51 across ramp 77, and ramp 77 moves pin guide 51 upwardly, which aligns contact pin 53 with an opening 79 in guide piece 19 and along longitudinal axis X. Immediately upon the alignment of contact pin 53 with opening 79, impact spring 61 drives contact pin 53 out of opening 79 and into the window glass. Contact pin 53 continues its movement until bulb end 57 of contact pin 53 strikes a stop wall 81 (FIGS. 14, 15) having a hole through which contact pin 53 extends, the hole being of smaller diameter than that of bulb end 57 but slightly longer than the diameter of contact pin 53.

Resetting of contact pin 53 and impact spring 61 is simple pursuant to the perception of the user. Once the user releases hand pressure from guide piece 19, pressure on reset spring 71 is relaxed, and reset spring 71 relaxes as well. Reset spring 71 moves guide piece 19 to its extended position as shown in FIGS. 11 and 13-15. An end 83 of reset spring 71 (FIG. 15), which is proximate bulb end 57 of contact pin 53, is held fast in an interior wall of housing 3. An end 85 of reset spring 71 is urged by its spring force against an interior wall 87 of housing 3. Reset spring 71 does not extend into guide piece 19. The urging by reset spring 71 of guide piece 19 into its extended position and the engagement of impact spring 61 and rib 65 move contact pin 63 to extend along the imaginary line X′. Pin guide 51 engages arcuate wall section 75 to reset compression spring arrangement 59. With this ease of resetting, auto emergence tool 1 can be used repeatedly until whatever window needs to be broken has been accomplished.

Emergency device 1 includes a light emitter assembly 88, and assembly 88 is composed of an LED 89 which is in turn part of a dome assembly 91, the latter also including translucent dome member 9. Translucent dome member 9 has a circuit support plate 93 which holds a pair of legs 95 extending from LED 89 (FIGS. 16 and 18). Also extending from circuit support plate 93 between legs 95 is a compression spring 97 (FIG. 18). Right housing part 5 and left housing part 7 have component parts of a battery compartment 98 having a front battery support wall 99 (FIG. 16). Dome assembly 91 has a pair of rearwardly extending side walls 103 and 105 (FIG. 18) for cooperating with battery support wall 99 to hold a set of batteries 107 in place. In the preferred embodiment, three AG10 button cell batteries are used. Compression spring 97 presses a set of batteries 107 against a battery support wall 101 included in housing part 107. Set of batteries 107 lies along longitudinal axis X.

Circuitry is provided for actuating LED 89. A metal contact 109 extends from a conductive metal sheet 111 (FIG. 18) which is attached to the forward part of the side wall of left housing part 7 which in turn contributes in holding set of batteries 107. Contact 109 extends across an opening defined in part by edges 113 in left part 7 and edges 115 in right part 5 to together form a button opening 117. Finger button 119 is part of a button assembly 121. Button assembly 121 is preferably injection molded as an integral unit. Button assembly 121 includes an integral leaf spring 123. When button assembly 121 is installed in auto emergency tool 1, leaf spring 123 is held between the interior of a top wall 125 and a parallel inner wall 127 (FIG. 17). A connecting piece 129 (FIGS. 17, 18) also rests against the inner part of top wall 125 to assist in positioning leaf spring 123 and finger button 119. Operation of a flashlight incorporating LEDs is very simple. A set of small partitions 133 position each of the set of batteries 107 to lie along axis X.

There are a number of features of auto emergency tool 1 which offer important advantages. Auto emergency tool 1 is ergonomic. Tool 1 can easily be held in one hand, and if the flashlight incorporating LED 89 is to be used, the user simply grips the lower portion of projecting portion in the person's fingers where it can be held firmly in place with the thumb positioned over finger button 119. The stronger portion of a user's hand is over the flashlight being operated. The user simply presses down on button 119 to actuate LED 89. A release of finger pressure on button 119 would turn off LED 89 due to the memory of a resilient plastic of which button assembly 121 is made. In the event the user wants to break the glass of the side window of a motor vehicle, the user simply directs tool 1 towards the front of the user, reverses the position of tool 1 (so guide piece 19 is directly forwardly) in the user's hand with the fingers wrapped around the outer portion of tool 1 with the thumb wrapped around the other side of tool 1. The user can easily press guide piece 119 against the window to actuate glass-breaking mechanism 49, with contact pin 53 being driven in the direction of the glass to break the glass. Since the user's thumb is wrapped around the rearward portion of tool 1 adjacent guide piece 19, a firm grip is made for holding tool 1 against the glass window for withstanding the impact against tool 1 as contact pin 53 strikes the glass, and a firmer grip occurs than would exist if the thumb and fingers were more widely separated. The device, in its preferred form, is small enough for ease of manual use while enabling easy storage of tool 1 on a keyring, if necessary, which can disposed in the user's pocket, in a handbag or on a rearview mirror or other appropriate place in the motor vehicle.

In its preferred form, auto emergency tool 1 has a height h₁ as shown in FIG. 10 of 31.44 mm, or about 1.24 inches, and a height h₂ at the end with guide piece 19 of 19 mm, or about 0.79 inches, as shown in FIG. 9. The portion of auto emergency tool 1 having the greatest height, as shown at h₃ in FIG. 5, is 31.44 mm, or about 1.24 inches. The length of tool, as shown by 1 in FIG. 7, is 65.95 mm, or about 2.60 inches. The width of tool 1 is constant, and as shown in FIG. 7 by w, is 10.6 mm, or about 0.42 inches. The ratio of the thickness of the rearward end to the thickest part h₃ is about 19.00:31.44, giving the firm grip for glass breaking as mentioned just above. The ratio would range from 15.0:28.0 to 25.0:37.5.

There are other important features of auto emergency tool 1, the gentle curve of surface 31 can have a uniform radius of curvature, but has been found particularly effective for both facilitating the cutting of seat belts and rendering tool 1 both compact and ergonomic by having increasing radii of curvature for different portions of the gentle curve extending from joining portion 27 to the forward end of notch 15. In a preferred embodiment, the gentle curve of surface 31, running forwardly from joining portion 27, includes a first portion has a radius of curvature of about 1 inch, a second portion immediately forward of the first portion having a radius of curvature in the range of 3.5 to 4.0 inches, a third portion immediately forward of the second portion having a radius of curvature in the range of 7.0 to 7.5 inches and a fourth portion extending immediately forward of the third portion having a radius of curvature in the range of 9.3 to 9.7 inches.

Likewise, the gentle curve has been found to be particularly effective by dividing the gentle curve into the foregoing portions having a high angle commencing at said joining portion 27 to a second portion including part of cutting edge of knife blade 41 at a lesser angle, to a third portion having a still shorter angle and finally to a slightly larger angle which terminates at detent 29.

Bottom curved surface 32 of projecting portion 25 preferably has a constantly curved surface. Since the rearward end where guide piece 19 is located is narrower than the front end since that notch 15 is the narrowest, this curved surface enables a firm grip to withstand the impact of the glass-breaking mechanism 49 when it is in the act of breaking glass. The foregoing radius of curvature should be less than at least the portion of surface 32 which is on the opposite side of more than the forward half of body-facing side 31 of projecting portion 25—and more specifically on the opposite side of portions 143 and 144 (FIG. 23) discussed below.

As shown in FIG. 22, cutting edge 41 of knife blade 39 makes an angle β with the projecting portion-facing side 35 of body 23. Angle β and the angle(s) γ and Ω, at which auto emergency tool 1 rides toward and through a seat belt, control to a large part the cutting of a seat belt and are significant with respect to the present invention in its preferred form. This is because tool 1 is moved by a user towards a seat belt worn by the user basically along body-facing side 31 of projecting portion 25 towards and through cutting edge 41. A particularly good set of angles is shown in FIG. 22. Angle β is preferably about 157°, but which could fall within a range of 135°-165°. Cutting edge 41 also makes an angle λ with the curved part (identified below as a second portion 139) of body-facing side 31 of projecting portion 25 which is preferably about 37°, but which could fall within the range of 25°-55°. Body-facing side 31 of projecting portion 25 has been found to be very effective with three curved portions. As shown in FIG. 22, a first portion 137 proximate joining portion 27 has a radius of curvature R₁ of about 1.09 inches (R₁ was measured at 1.094 inches, and could fall within a range of 0.75 to 1.00 inches) through an angle γ as shown of about 12.7°, and second portion 139 proximate first portion 137 has a radius of curvature R₂ of about 3.875 inches (which could range from about 2.6 inches to about 4.0 inches) through an angle Ω of about 6° (measured at 5.97°, and could be between 4° to 7°) which is stepped radially inwardly at a shoulder 141 of about 1 mm to a third portion 143. Third portion 143 extends through another angle Ψ shown in FIG. 23 with a radius of curvature of about 7.3 inches (which was measured at 7.313 inches and could be in the range of about 7.0 to 7.5 inches with angle Ψ equaling about 3.7° (angle Ψ was measured at 3.66°, but it could run from 3° to 5.5°). Still referring to FIG. 23, a fourth position 144 lies between third portion 143 and detent 29 and has a radius of curvature of about 9.5 inches (measured at 9.500 inches), which could be in the range of 9.0 to 10.0 inches, and extends through an angle ρ of about 4.3° (angle ρ was measured at 4.25°, but could range from 4° to 5°. As mentioned earlier, the radius of curvature of bottom surface 32 of projecting portion 25 is less than R₃ and R₄, and is preferably about 4.75 inches. These segments R₁ to R₄ could have various sizes and ranges, could merge into fewer or more curved portions, and provide a generally smooth curve (other than detent 29) for enabling auto emergency tool 1 to pass an auto seat belt into notch 15 and enable knife blade 39 to cut the seat belt easily and quickly.

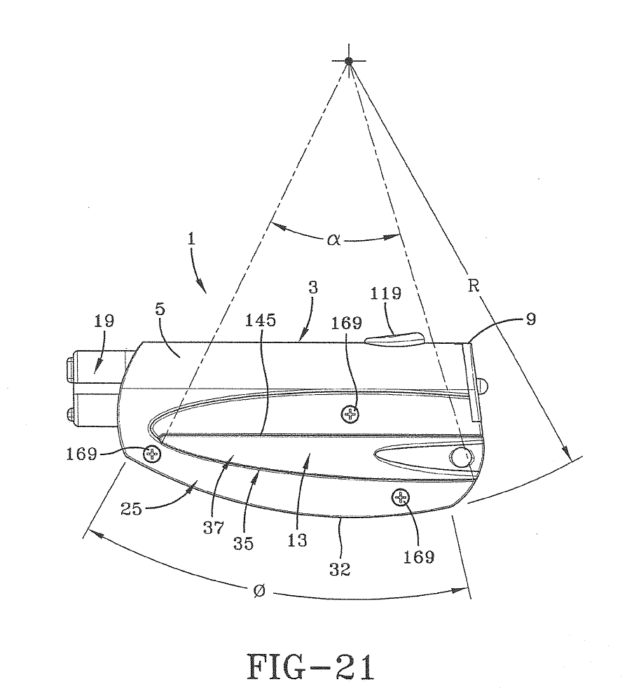

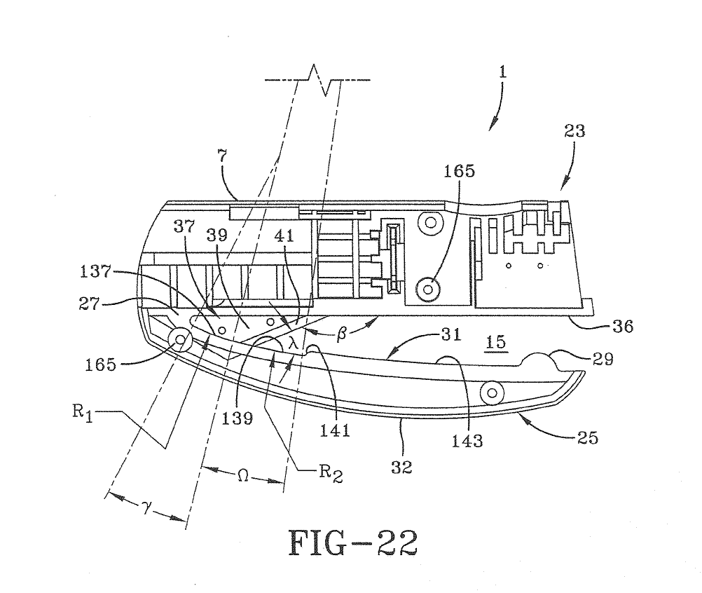

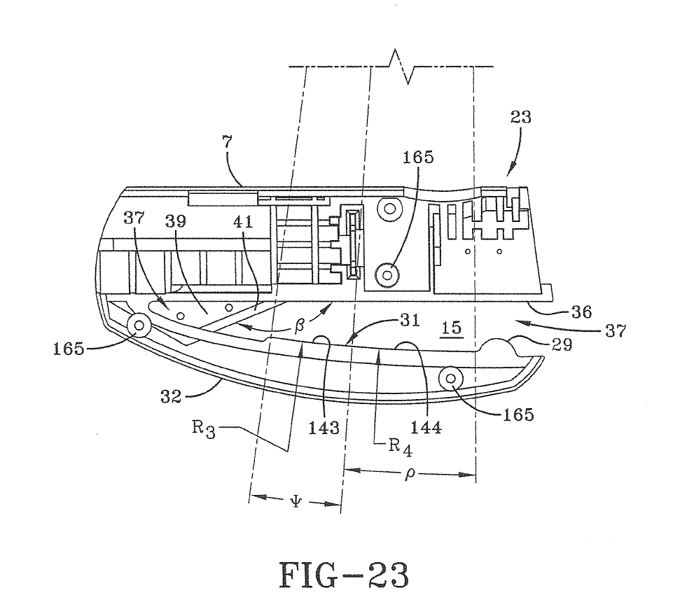

As shown in FIG. 21, body-facing side 31 of projecting portion 25 has an outside radius of curvature R of preferably 3.25 inches and a length of preferably 2.375 inches, with one angle Φ of preferably 42°. Angle Φ could range between 30°-50°. Its interior radius of curvature is preferably about 2.75 inches, with an angle α of preferably about 45° for facilitating the cutting of a seat belt by knife blade 39. Angle α could range between 30° and 55°.

Referring to FIGS. 19, 20 and 24, projecting portion-facing side 35 of blade cover 13 has a like curved configuration corresponding to that of the body-facing portion 31 of projecting portion 25, and an upper part 145 of blade cover 13 is configured to match that of the top part of notch 15 defined by main portion 23. A lower part 147 of blade cover 13 has indented path 47 and indent 33, and upper part 145 of blade cover 13 has a pair of support walls 149 and 151 for lending lateral support to side walls 153 and 155, as shown in FIGS. 19 and 20.

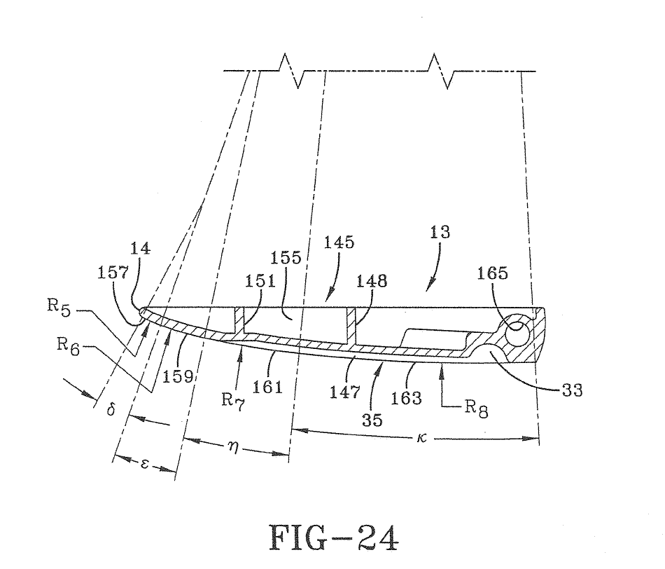

Still referring to FIG. 24, blade cover 13 is appropriately curved so that its curves correspond to those of projecting portion 24, adequately fill notch 15 and cover knife blade 39 precisely while enabling fast and easy insertion into, and removal from, notch 15 while being held firmly in place when knife blade 39 is not intended to be available for use in cutting a seat belt.

Blade cover 13 has a first portion 157 having a radius of curvature R₅ of 0.75 inches (but which could range between 0.5 and 1.0 inches) and has an angle δ of about 8.6° (measured at 8.63° , and could range between 7° and 10°). Blade cover 13 also has a second section 159 with a radius of curvature R₆ of 2.00 inches (which could be in the range of 1.875 to 2.125 inches) and at an angle ε of about 7.45° (which could be in the range of 7° to 8.30°). A third portion 161 of blade cover 13 has a radius of curvature of R₇ of 5.00 inches (which could range between 4.5 and 5.5 inches) and extends through an angle η of 6.22° (which could run between 5.7° and 7°). A fourth portion 163 of blade cover 13 has a radius of curvature R₈ of 9.34 inches (which could be in the range of 8.75 to 10.00 inches) and extends through an angle κ of 8.29° (but which could be between 8.00° and 9.00°).

Pull tab 21 is provided for isolating battery set 107 from the circuit to prevent any depletion of the batteries prior to use by a consumer.

Auto emergency tool 1 has been designed for easy assembly. Three threaded screw sockets 165 extend through housing side part 7, screw holes 167 corresponding thereto extend through housing side part 5 for receiving screw 169. Housing part 7 is injection molded, with knife blade 39, stop wall 81 and conductive metal sheet with contact 109 being insert molded at the time of molding. Pin guide 51 is preassembled as contact pin 53. Contact pin 53 is preassembled with compression spring arrangement 59. The latter items are then assembled with guide piece 19. The foregoing preassembled pieces, along with a set of batteries 107, are placed in housing part 7, housing part 5 put in place on housing part 7, and screws 161 are inserted through holes 17 into screw sockets 165. Auto emergency tool 1 is thus fully assembled.

As explained above, the invention in its preferred form is ergonomic, effective in use and extremely efficient in operation. Auto emergency tool 1 can easily be held and used by children or adults. Its length in its preferred form is only about 2½ inches, and it can easily fit in a person's hand. Its curved outer portion, having a generally lower periphery in the shape of a truncated egg, renders it easy to hold firm in its window-breaking mode. Its top is basically flat. It is generally half as high as the length of an adult's fingers, its length is less than the width of an adult's four fingers, and its width is no greater than the lower joint of a person's hand. The height of auto emergency tool at its glass-breaking end is no greater than the length of an adult's longer finger joint. The general ratio of the height of the glass-breaking end of auto emergency tool 1 to its greatest height is 0.7, showing that a firm grip can be employed as tool 1 is in the process of breaking glass. This ratio could be in the range of 0.875:2.000, with the component sizes being adjusted accordingly. The same is true as a user uses tool 1 to cut a seat belt, either moving tool 1 towards the user or away from the user for a belt extending across the user's lap, or across the user when tool 1 is being used to cut open an across-the-shoulder seat belt.

The invention has been described in detail, with particular emphasis on the preferred embodiment thereof, but variations and modifications may occur to those skilled in the art to which the invention pertains from the foregoing discussion and the appended claims.

I claim:

1. An auto emergency tool comprising:
an ergonomic housing including:
a main portion having a forward end with a light emitter assembly opening, a rearward end with a glass-breaker assembly opening, a longitudinally extending axis between the forward end and the rearward end, a top surface and projecting portion-facing bottom surface;
a joining portion proximate said rearward end and connected to said main portion; and
a projecting portion integrally connected to said main portion and extending from said joining portion to a free end proximate said forward end of said main portion, said projecting portion having a forward end proximate and generally aligned with the forward end of said main portion and a rearward end as part of said joining portion, an inner main portion-facing upper surface spaced from said projecting portion-facing bottom surface of said main portion to define a seat belt-receiving notch, said inner main portion-facing upper surface having a smooth gentle curve for facilitating the movement of said auto emergency tool towards a seat belt with the seat belt being positionable in said notch, and an outer smooth gentle surface for being graspable by a user's hand, said housing having proximate said rearward end a rearward height, said rearward height being less than the thickness of said housing proximate said forward end to enable a user to wrap the user's fingers around the rearward end and exert a firm and ergonomic grip on said housing;
a knife blade fixed to said housing and extending into said notch; and
a blade cover for being slid into and out of said notch, said blade cover comprising:
an upper part configured to correspond to said projecting body-facing side of said body portion, said upper part having a forward end and a rearward end;
a lower part configured to correspond to said main body-facing side of said projecting portion, said lower part having a forward end and a rearward end;
a nose portion interconnecting said rearward parts of said upper part and said lower part for engaging said joining portion in sliding engagement when said blade cover is inserted into said notch;
a slit-extending forwardly from said nose portion for receiving a portion of said blade cover extending into said notch in response to the insertion of said blade cover into said notch;
a light-emitter assembly disposed in said light-emitter assembly opening of said main portion of said housing, said light-emitter assembly including:
a light emitter for emitting light through said light emitter assembly; and
a switching circuit closable for connecting a power source to said light emitter, said switching circuit including a manually operable structure extending from said top surface of said main portion of said housing proximal said light emitter assembly opening, for closing said switching circuit; and
a glass-breaker assembly disposed in said glass-breaker assembly opening of said main portion of said housing, said glass-breaker assembly including an external guide piece and a spring-loaded plunger operably connected to said guide piece for being driven outwardly from said housing in response to the depression of said guide piece into said housing to break glass in the path of said plunger;
said blade cover being manually withdrawable to close or expose said knife blade for cutting a seat belt as said auto emergency tool is moved towards and through a seat belt disposable in said notch, said rearward end of said auto emergency tool being placeable against a motor vehicle window and said guide piece being depressible to release said plunger, and the forward end of said auto emergency tool being directable in a selected direction and said manually operable structure being operable to effect the emission of light from said light emitter.

2. An auto emergency tool according to claim 1 wherein the ratio of said rearward height of said housing to the thickness of the thickest part of said housing proximate said forward end of said housing is generally 19.00:31.44.

3. An auto emergency tool according to claim 1 wherein the ratio of said rearward height of said housing to the thickness of said housing proximate said forward end of said housing is generally 15.0:28.0.

4. An auto emergency tool according to claim 1 wherein the ratio of said rearward height of said housing to the thickness of said housing proximate said forward end of said housing is in the range of 15.0:28.0 to 25.0:37.5 .

5. An auto emergency tool according to claim 1 wherein said smooth gentle curve of said inner main portion-facing upper surface of said projecting portion comprises a curve having at least one radius of curvature falling in the range of 1 inch to 9.5 inches.

6. An auto emergency tool according to claim 1 wherein said seat belt-receiving notch has a narrowest portion proximate said joining portion and expands gradually to a widest portion proximate the rearward ends of said main portion and said projecting portion, and said nose portion of said blade cover has a narrow rearward end to fit in said narrowest portion in sliding engagement and a forward portion for fitting into said widest portion in sliding engagement.

7. An auto emergency tool according to claim 1, said gentle curve of said inner main portion-facing upper surface of said projecting portion is composed of at least two different merged curves having increasing radii of curvature from said joining portion to said free end.

8. An auto emergency tool according to claim 7 wherein said gentle curve has a first portion adjacent said joining portion with a radius of curvature of about 1 inch, a second portion extending forwardly from said first portion with a radius of curvature of between 3.5 and 4.0 inches, a third portion extending forwardly from said second portion with a radius of curvature of between 7.0 and 7.5 inches and a fourth portion extending forwardly from said third portion with a radius of curvature of between 9.3 and 9.7 inches.

9. An auto emergency tool according to claim 7 and further including a detent proximate the forward end of one of said main portion-facing upper surface of said projecting portion and said lower part of said blade cover and a corresponding indent on the other of said lower part of said blade cover and said main portion-facing upper surface of said projecting portion, said detent and said indent cooperating to facilitate holding said blade cover in said notch when said blade cover is inserted in said notch and said nose portion of said blade cover engages said joining portion of said housing.

10. An auto emergency tool according to claim 1 wherein said outer smooth gentle surface of said projecting portion has a radius of curvature which is less than the radius or radii of curvature more than half of the forward part of said inner main portion-facing upper surface of said projecting portion.

11. An auto emergency tool according to claim 10 wherein said radius of curvature of said outer smooth gentle surface of said projecting portion is about 4.75 inches.

12. An auto emergency tool according to claim 10 wherein said radius of curvature of said outer smooth gentle surface of said projecting portion is in the range of 3.0 to 9.0 inches.

13. An auto emergency tool according to claim 1 and further including a screw and longitudinally-extending socket assembly in said light emitter assembly and the forward end of said housing, said screw extending longitudinally through said light emitter assembly to fasten said light emitter assembly to said housing.

14. An auto emergency tool according to claim 13 and further including a battery compartment extending rearwardly of the light emitter assembly, said light emitter assembly being removable to establish access to said battery compartment to enable battery loading and unloading in said battery compartment.

15. An auto emergency tool according to claim 10 and further including battery support wails for aligning a set of cell batteries longitudinally in said battery compartment.

16. An auto emergency tool according to claim 1 wherein said projecting portion-facing bottom surface of said main portion is flat, and said knife blade intersects said projecting portion-facing bottom surface at an exterior, obtuse angle.

17. An auto emergency tool according to claim 16 wherein said obtuse angle is in the range of 135° to 165°.

18. An auto emergency tool according to claim 16 wherein said gentle curve of said inner main portion-facing upper surface of said projecting portion has a rearward end, said latter rearward end being intersected by said knife blade.

19. An auto emergency tool according to claim 17 wherein said knife blade intersects said rearward end of said gentle curve of said inner main portion-facing upper surface of said projecting portion at an exterior acute angle in the range of 25° to 55°.
